(19) United States
(12) Patent Application Publication
(10) Pub. No.: US 2016/0341682 A1
(43) Pub. Date: Nov. 24, 2016

(54) THERMAL CONDUCTIVITY DETECTOR

(71) Applicant: Siemens Aktiengesellschaft, Muenchen (DE)

(72) Inventor: Udo GELLERT, Bellheim (DE)

(73) Assignee: Siemens Aktiengesellschaft

(21) Appl. No.: 15/157,770

(22) Filed: May 18, 2016

(30) Foreign Application Priority Data
May 20, 2015 (DE) 10 2015 209 200.3

(51) Int. Cl. G01N 25/18

(52) U.S. Cl. CPC G01N 25/18

(57) ABSTRACT

A thermal conductivity detector with a bar which is arranged in the center and in the longitudinal direction of a channel such that it can be flowed around by a fluid and is supported unilaterally on a support traversing the channel, which has a support arm on each of the two sides of the connection with the bar, wherein the bar and the support are made of doped silicon and on one side, under an intermediate layer of an insulating layer, have a metal layer which is interrupted in one region of one of the support arms and is in contact there with the doped silicon through the insulating layer on the side next to the support arm and at the free end of the bar respectively.

### BACKGROUND OF THE INVENTION

1. Field of the Invention

The invention relates to a thermal conductivity detector including a bar arranged in the center and in the longitudinal direction of a channel of the detector such that fluid can flow around the bar.

2. Description of the Related Art

WO 2009/095494 A1 discloses a thermal conductivity detector with an electrically heatable filament that is mounted such that fluid can flow around the bar in the center and in the longitudinal direction of a channel, and for this purpose is supported at both its ends on two electrically conductive supports traversing the channel. To maintain a long service life and high level of inertness compared with chemically aggressive gas mixtures, the filament and the supports are made of doped silicon. The doped silicon can be applied to a silicon substrate under an intermediate layer of an insulating layer of silicon dioxide, where during etching processes the supports and the filament are formed and the groove in the support plate is shaped by structuring the silicon substrate, the silicon dioxide layer and the layer of doped silicon.

EP 1 381 854 B1 also discloses similar thermal conductivity detectors with metal filaments, in particular gold and/or platinum. Here, the filament under tension at ambient temperature may slacken at operating temperatures between 100° C. and 200° C. or higher on account of its thermal expansion so that the fluid flowing through the channel may induce vibrations in the filament, which increase the detector noise of the thermal conductivity detector and consequently lower the detection limit, and which may also lead to premature breakage of the very thin filament. To counter slackening of the filament at operating temperature, at least one of the two supports is designed such that the distance between it and the other support is greater in the region of the center of the channel than in the region of the channel walls.

Designing the metal filament as a film or layer in or on a supporting material is also known.

U.S. Pat. No. 4,682,503 A thus discloses a thermal conductivity detector in which the filament is embedded as a metal film in a bar that extends in a longitudinal direction across a groove and is supported at both ends, such as on supports extending across the groove. The bar and the supports are made of a dielectric material, such as silicon nitride, which is designed as a layer on a silicon substrate, where the bar with the supports and the groove have been shaped in the silicon nitride layer or the silicon substrate via etching. The metal film, preferably made of an iron-nickel alloy, can be taken straight from one end of the bar to the other or, as a loop at one end, taken back.

U.S. Pat. No. 4,594,889 A1 discloses an air mass sensor operating in accordance with the principle of a hot-wire anemometer in which two parallel rectangular openings are formed in a plate-shaped silicon substrate between which the silicon forms a wire-shaped element. The silicon substrate is covered with a silicon dioxide layer upon which a metal layer, for example, of platinum, forming the filament is formed in the region of the wire-shaped element. The metal layer covers the silicon substrate at both ends of the wire-shaped element and forms contact surfaces there.

Compared with the mechanical stability of a gold thread, the mechanical stability of silicon is considerably higher. However, as silicon is relatively brittle and, which is advantageous, a filament of doped silicon can be operated at a higher operating temperature, thermal expansion is also a problem for such a filament.

### SUMMARY OF THE INVENTION

It is therefore an object of the invention to provide a thermal conductivity detector that solves the foregoing problems.

This and other objects and advantages are achieved in accordance with the invention by a thermal conductivity detector with a bar that is arranged such that fluid can flow around the bar in the center and in a longitudinal direction of a channel, where the bar is supported unilaterally on a support traversing the channel, with a support arm on both sides of the connection with the bar respectively, and where the bar and the support consist of doped silicon and, on one side, support a metal layer under an intermediate layer of an insulating layer that is interrupted in the region of one of the support arms and there on the side adjacent to the support arm and at the free end of the bar respectively is in contact with the doped silicon through the insulating layer.

The mechanical stability of silicon permits the replacement of the known metal filaments clamped on both sides by an extremely thin cantilever of doped silicon. As a result of its unilateral support, during thermal expansion the bar is not exposed to any mechanical stress. On account of its comparatively high electrical resistance, the doped silicon forms a heating element or filament which at its ends, i.e., at the free end of the bar and in the region of one of the support arms, is in contact with the metal layer serving as a power supply.

The thermal conductivity detector in accordance with the invention is advantageously produced micromechanically, preferably with silicon dioxide or silicon nitride for the insulating layer and preferably gold or platinum for the metal layer.

In order to increase the mechanical stability and to be able to provide different electrical resistance values, the thermal conductivity detector in accordance with the invention preferably has at least one other identically structured and supported bar that is arranged immediately in front of or behind the first bar in the longitudinal direction of the channel. In this way, the heating element or filament is divided into a number of segments that are each more mechanically stable individually, but act as a single continuous filament with regard to the fluid flowing around them. When the filament segments are connected in series, their combined resistance corresponds to the resistance of the comparable single continuous filament, when connected in parallel, to a fraction of the resistance of the single filament.

In order to ensure that in any case the thermal conductivity detector operates regardless of the installation position in a line conducting the fluid, with an even number of bars, they are preferably arranged in a mirror image in relation, to an axis running across the channel.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail hereinafter with reference to the figures of the drawings; the drawing, in which:

FIG. 1 is an illustration of a first exemplary embodiment of the thermal conductivity detector in accordance with the invention in a longitudinal section (I-I′);

FIG. 2 is an cross-sectional illustration (II-II′) of the thermal conductivity detector of FIG. 1;

FIG. 3 is an exemplary illustration of a longitudinal section (III-III′) through a portion of the support arm and the contiguous bar; and

FIG. 4 is an illustration of a second exemplary embodiment of the thermal conductivity detector in accordance with the invention with three bars; and

FIG. 5 is an illustration of an exemplary embodiment of the thermal conductivity detector according to the invention with four bars.

### DETAILED DESCRIPTION OF THE EXEMPLARY EMBODIMENTS

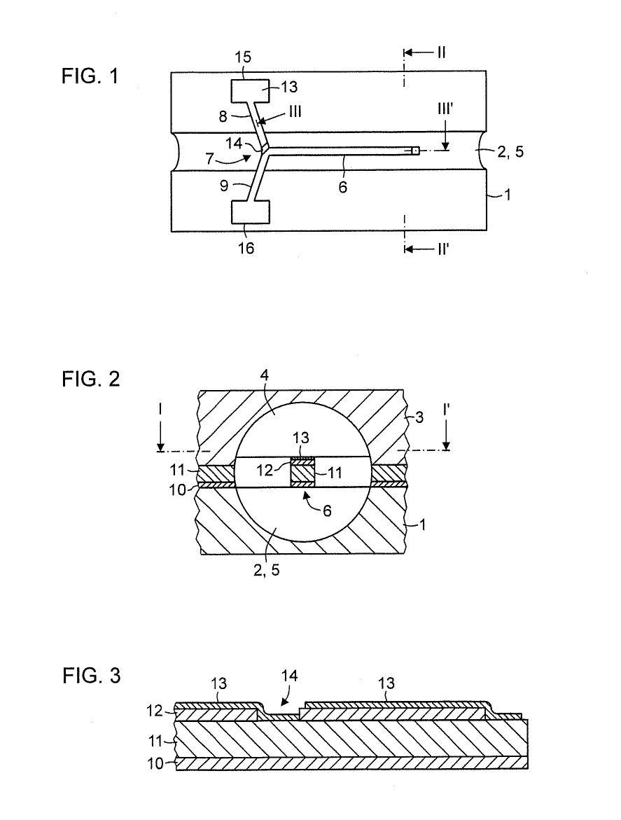

As FIGS. 1 and 2 show, on a support plate 1 with a groove 2 contained therein, a cover plate 3 with another groove 4 is located such that both grooves 2 and 4 together form a channel 5 with a circular cross-section here. In the center of the channel 5, a bar 6 extends in its longitudinal direction that is supported at one end on a support 7 traversing the channel 5. The support 7 has one support arm 8, 9 on each of the two sides of the connection with the bar 6.

FIG. 3 shows a longitudinal section through a portion of the support arm 8 and the contiguous bar 6.

For micromechanical production of the thermal conductivity detector, the support plate 1 is initially constructed from a silicon substrate to which an insulating layer 10 of silicon dioxide is applied. A layer 11 of doped silicon is then applied to the silicon dioxide layer 10. In etching processes, the support 7 with the bar 6 is formed and the groove 2 in the support plate 1 is shaped by structuring the silicon substrate, the silicon dioxide layer 10 and the layer of doped silicon. When shaping the support 7 and the bar 6, the silicon dioxide layer 10 need not be retained inside the groove 2.

The support 7 and the bar 6 obtain a hydrogen sulfide-resistant surface (insulating layer) 12 of silicon dioxide through oxidation. On their upper side, the bar 6 and the support 7 have a metal layer 13 that is interrupted at the point designated by 14 in the region of the support arm 8, and at this location is in contact with the doped silicon 11 on the side next to the support arm 8 through the insulating layer 12. At the free end of the bar 6, the metal layer 13 is likewise in contact with the doped silicon 11 through the insulating layer 12. Finally, the support plate 1 and the cover plate 3 are combined, where the grooves 2 and 4 shaped therein form the channel 5.

The support arms 8, 9 end in contact surfaces 15, 16, by way of which the thermal conductivity detector can be switched to a measurement bridge. A filament current flows from the contact surface 15 over the metal layer 13 of the support arm 8 to the point 14, where it is introduced into the doped silicon 11. From there, the current flows through the bar 6 to its free end where it again enters the metal layer 13 and flows to the contact surface 16.

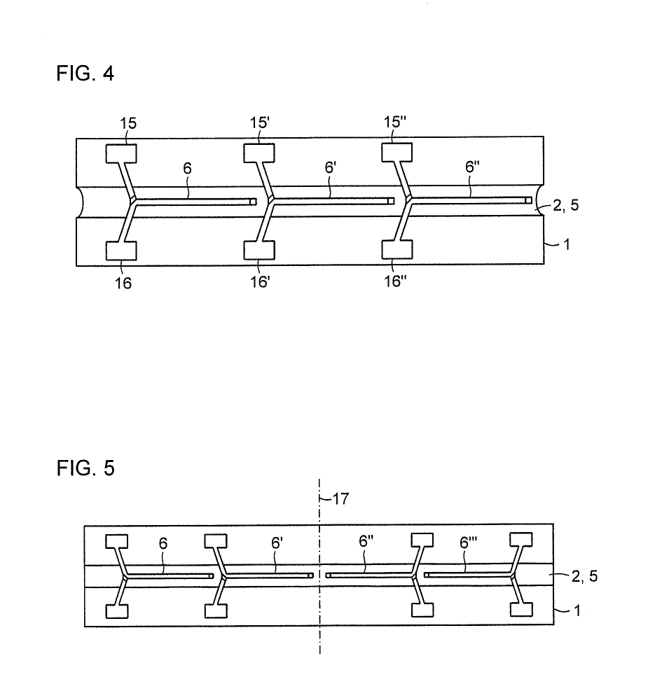

FIG. 4 shows an exemplary embodiment of the thermal conductivity detector in accordance with the invention with three structurally identical bars 6, 6′, 6″ that are arranged in immediate succession in the longitudinal direction of the channel 5. By connecting the contact surfaces in accordance with the pattern 15-15′-15″ and 16-16′-16″, the bars 6 can be connected in parallel and by connecting in accordance with the pattern 16-15′ and 16′-15″, in series.

FIG. 5 shows an exemplary embodiment with four structurally identical bars 6, 6′, 6″, 6′″ that are arranged in a mirror image in relation to an axis 17 extending across the channel 5, the thermal conductivity detector thus having no preferred direction for installation in a fluid line.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A thermal conductivity detector comprising:
a channel;
a bar arranged in a center and in a longitudinal direction of the channel of the detector such fluid can flow around said bar;
a support traversing the channel and unilaterally supporting the bar; said support having a support arm on each of two sides of a connection with the bar;
wherein the bar and the support are made of doped silicon and on one side, under an intermediate layer of an insulating layer, have a metal layer which is interrupted in one region of one of support arm and is in contact there with the doped silicon through the insulating layer on a side adjacent to the support arm and at a free end of the bar, respectively.

2. The thermal conductivity detector as claimed in claim 1, where in the insulating layer is made of silicon dioxide.

3. The thermal conductivity detector as claimed in claim 1, wherein the metal layer is made of gold.

4. The thermal conductivity detector as claimed in claim 2, wherein the metal layer is made of gold.

5. The thermal conductivity detector as claimed in claim 1, further comprising:
at least one further identically structured and supported bar which is arranged immediately before or after a first bar in the longitudinal direction of the channel.

6. The thermal conductivity detector as claimed in claim 5, further comprising:
an even number of bars arranged in a mirror image in relation to an axis extending across the channel.

7. The thermal conductivity detector as claimed in claim 5, wherein heating elements formed by bars and the metal layers supported thereby are connected electrically in parallel.

8. The thermal conductivity detector as claimed in claim 6, wherein heating elements formed by the bars and the metal layers supported thereby are connected electrically in parallel.

9. The thermal conductivity detector as claimed in claim 5, wherein heating elements formed by bars and the metal layers supported thereby are connected electrically in series.

10. The thermal conductivity detector as claimed in claim 6, wherein heating elements formed by the bars and the metal layers supported thereby are connected electrically in series.
